(19) United States
(12) Patent Application Publication
(10) Pub. No.: US 2008/0239061 A1
(43) Pub. Date: Oct. 2, 2008

(54) FIRST PORTABLE COMMUNICATION DEVICE

(76) Inventors: Ronald S. Cok, Rochester, NY (US); John N. Border, Walworth, NY (US); Patrick A. Cosgrove, Honeoye Falls, NY (US); Lynn Schilling-Benz, Fairport, NY (US)

Correspondence Address: Frank Pincelli;Patent Legal Staff, Eastman Kodak Company, 343 State Street, Rochester, NY, 14650-2201, US

(21) Appl. No.: 11/693,995

(22) Filed: Mar. 30, 2007

(51) Int. Cl. H04N 7/14

(52) U.S. Cl. 348/14.02; 348/E07.078

(57) ABSTRACT

In accordance with this invention, there is provided a first portable communication device for communicating with a second portable communication device, the first portable communication device including a communication module for transmitting and receiving video and audio information; an electronic display; a first image capture device for capturing an image of a first scene; a second image capture device for capturing an image of a second scene different from the first scene and way that is responsive to a user command for transmitting images of either the first or second scene or a combination thereof to the second portable communication device.

### FIELD OF THE INVENTION

The present invention relates to two-way video communication systems and, more particularly, to portable cellular telephones.

### BACKGROUND OF THE INVENTION

Two-way video systems are available that include a display and camera in each of two locations connected by a communication channel that allows communication of video images and audio between two different sites. Originally, such systems relied on setup at each site of a video monitor to display a remote scene and a separate video camera, located on or near the edge of the video monitor, to capture a local scene, along with microphones to capture the audio and speakers to present the audio thereby providing a two-way video and audio telecommunication system between two locations.

Referring to FIG. 10, a typical prior-art two-way telecommunication system is shown wherein a first viewer 71 views a first display 73. A first image capture device 75 captures an image of the first viewer 71. If the image is a still digital image that is stored in a first still image memory 77 for retrieval. A still image retrieved from first still image memory 77 or video images captured directly from the first image capture device 75 will then be converted from digital signals to analog signals using a first D/A converter 79. A first modulator/demodulator 81 then transmits the analog signals using a first communication channel 83 to a second display 87 where a second viewer 85 can view the captured image(s).

Similarly, second image capture device 89 captures an image of second viewer 85. The captured image data is sent to a second D/A converter 93 to be converted to analog signals but can be first stored in a second still image memory 91 for retrieval. The analog signals of the captured image(s) are sent to a second modulator/demodulator 95 and transmitted through a second communication channel 97 to the first display 73 for viewing by first viewer 71.

Although such systems have been produced and used for teleconferencing and other two-way communications applications, there are some significant practical drawbacks that have limited their effectiveness and widespread acceptance. Expanding the usability and quality of such systems has been the focus of much recent research, with a number of proposed solutions directed to more closely mimicking real-life interaction and thereby creating a form of interactive virtual reality. A number of these improvements have focused on communication bandwidth, user interface control, and the intelligence of the image capture and display components of such a system. Other improvements seek to integrate the capture device and display to improve the virtual reality environment. One significant drawback of such systems is their expense and lack of portability. Moreover, in an uncontrolled environment, audio noise can substantially reduce clarity and it can be difficult for a user to control the video imagery.

Referring to FIG. 11, existing cellular telephones 100 typically incorporate a communications module (not shown), a keypad 26 for user interaction, an imaging device 16 for taking pictures through an integrated lens, and a display screen 14 for displaying instructions and status to a user. Such devices 100 are useful for audio communication but are not generally employed for video communication, although digital images taken by the telephone can be transmitted and Internet content may be downloaded and displayed. A wide variety of designs incorporating sensors and displays are known in the art. For example, U.S. Patent Application Publication No. 2005/0128332, entitled “Display apparatus with camera and communication apparatus” by Tsuboi describes a portable display with a built-in array of imaging pixels for obtaining an almost full-face image of a person viewing a display. U.S. Patent Application Publication No. 2006/0007222, entitled “Integrated sensing display” by Uy discloses a display that includes display elements integrated with image sensing elements distributed along the display surface. A number of other attempts to provide suitable optics for two-way display and image capture communication have employed pinhole camera components. For example, U.S. Pat. No. 6,888,562 entitled, “Integral eye-path alignment on telephony and computer video devices using a pinhole image sensing device” to Rambo et al., describes a two-way visual communication device and methods for operating such a device.

One difficulty with a number of conventional solutions relates to an inability to compensate for observer motion and changes in the field of view. This may be addressed in part by providing cameras with rotatable covers having a variety of positions, some of which may provide a support to the display component. For example, US 2003/0227676 entitled “Image Display having a Cover Member” illustrates such covers. Among other approaches to this problem have been relatively complex systems for generating composite simulated images, such as that described in U.S. Patent Application Publication No. 2004/0196360 entitled “Method and apparatus maintaining eye contact in video delivery systems using view morphing” by Hillis et al. Another approach to this problem is proposed in U.S. Pat. No. 6,771,303 entitled “Video-teleconferencing system with eye-gaze correction” to Zhang et al. that performs image synthesis using head tracking and multiple cameras for each teleconference participant. However, such approaches avoid the imaging problem for integrated display and image-capture devices by attempting to substitute synthesized image content for true real-time imaging and thus do not meet the need for providing real-life interaction needed for more effective video-conferencing and communication.

Another difficulty encountered with image communication via cellular telephone is that with a conventional arrangement, it is difficult for a user to take a picture of him or her, or held objects. Camera shake can reduce the image quality of a scene. If an image of the user is desired, the difficulty is greater, in that the sensors are not typically oriented such that a user may both see the acquired image on the display and take a picture of himself or herself. Issues of focal distance and relative orientation are also problematic.

Hence, proposed solutions do not adequately meet the need for practical, portable telephony. The proliferation of solutions proposed for improved teleconferencing and other two-way video communication shows how complex the problem is and indicates that significant problems remain.

### SUMMARY OF THE INVENTION

In accordance with this invention, there is provided a first portable communication device for communicating with a second portable communication device, the first portable communication device including a communication module for transmitting and receiving video and audio information; an electronic display; a first image capture device for capturing an image of a first scene; a second image capture device for capturing an image of a second scene different from the first scene and a way that is responsive to a user command for transmitting images of either the first or second scene or a combination thereof to the second portable communication device.

### ADVANTAGES

The present invention provides a two way first portable communication system that can easily image both a user and a scene, reduce ambient noise to clarify audio communication, and provide way for user-friendly steady, hands-free image acquisition, accurate image capture, and image capture of held objects.

### BRIEF DESCRIPTION OF THE DRAWINGS

In the detailed description of the preferred embodiments of the invention presented below, reference is made to the accompanying drawings in which:

FIG. 1 is a perspective of the first portable communication device employing a folded mechanical stand according to an embodiment of the present invention;

FIG. 2 is a side view of the first portable communication device of FIG. 1 with the mechanical stand in an extended state according to an embodiment of the present invention;

FIG. 3 is a perspective of the first portable communication device of FIG. 1 with a mechanical stand located in an alternative position according to an alternative embodiment of the present invention;

FIG. 4 is a perspective of the first portable communication device with a separate mechanical stand according to another embodiment of the present invention;

FIG. 5 is a side view of the first portable communication device with a detachable mechanical stand according to another embodiment of the present invention;

FIG. 6 is a side view of the first portable communication device having two folding portions and a mechanical stand that can be oriented at different angles according to another embodiment of the present invention;

FIG. 7 is a block diagram of the first portable communication device having multiple image sensors and microphones according to yet another embodiment of the present invention;

FIG. 8 is a block diagram of the first portable communication device having a shared image sensor and separate lenses according to an embodiment of the present invention;

FIG. 9 is perspective of a personal communication system employing a plurality of first portable communication devices according to an embodiment of the present invention;

FIG. 10 is a block diagram of a typical prior-art telecommunication system;

FIG. 11 is a block diagram of a typical prior-art cellular telephone;

FIG. 12 is a block diagram of an embodiment of the present invention; and

FIG. 13 is a block diagram of a communication module useful in the present invention.

### DETAILED DESCRIPTION OF THE INVENTION

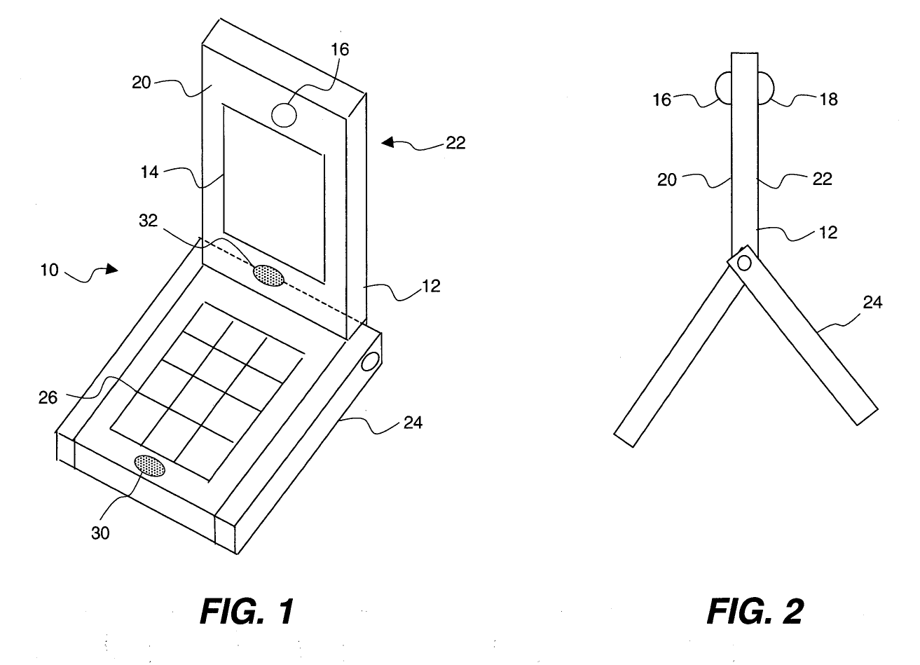

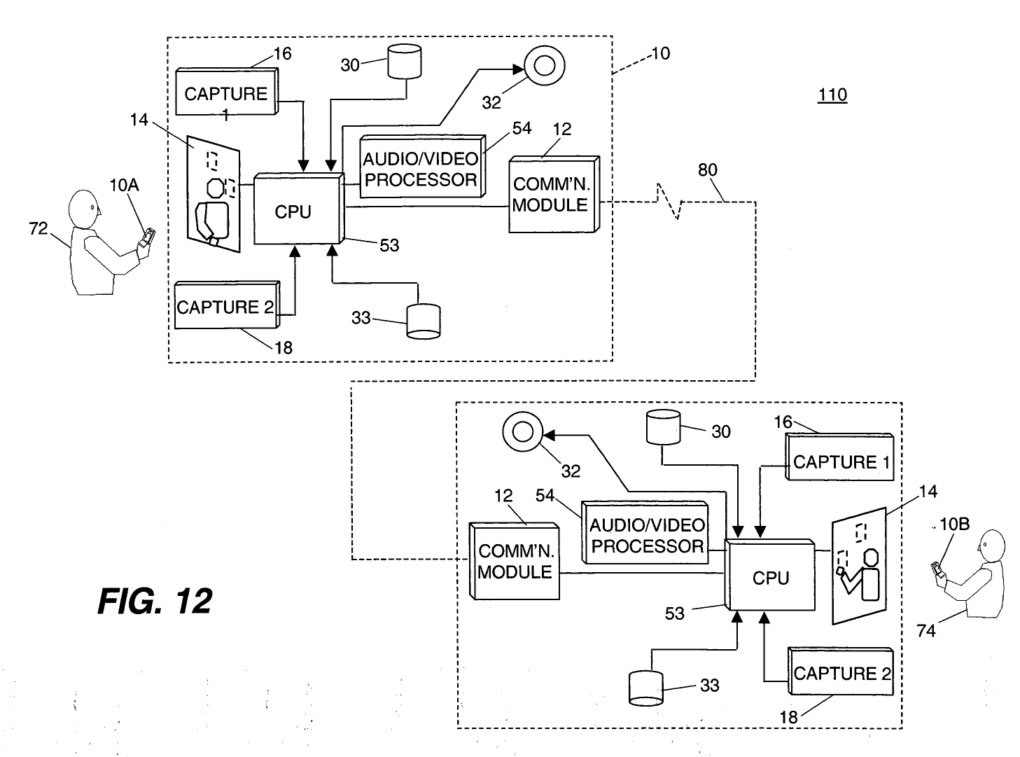

Referring to FIGS. 1, 2, and 12, according to one embodiment of the present invention, a first portable communication device 10, 10A includes a communication module 12 for transmitting and receiving still, video, and audio information, an electronic display 14 for displaying still or video images on a first side 20 of the first portable communication device 10, a first image capture device 16 for capturing still or video images from the first side 20 of the first portable communication device 10 of a first scene, a second image capture device 18 for capturing still or video images from a second side 22 of the first portable communication device 10 of a second scene different from the first scene, and responsive to a user command for transmitting images of either the first or second scene or a combination thereof to the second portable communication device 10B. Such user commands can be provided in a variety of ways, for example through a keypad 26, through an audio interface such as a microphone 30, or through a display 14 with a touchscreen. As shown in FIG. 12, the structure responsive to a user command includes, CPU 53 and audio/video processors 54. The first image capture device 16 and second image capture device 18 can be employed simultaneously or individually.

The user command can further include the structure for displaying an image of the first scene on the electronic display 14 and for selecting portions of such image to be combined with the second scene prior to transmitting the combined image. For example, the image of the user face as captured by the first image capture device can be extracted and combined with a scene image captured by the second image capture device to form a combined image. Alternatively displays responsive to a user command for displaying images of either the first or second scene can be provided.

A microphone 30 captures audio information for transmitting such audio information as the images are transmitted. At least one speaker 32 is provided for broadcasting audio information. The microphone 30 currently is placed adjacent to the first scene and located on the first side for capturing audio signal produced in the first scene. The first portable communication device can further receive and display video images from the second portable communication device and for receiving and playing audio received from the second portable communication device.

A mechanical stand 24 is integrated into the first portable communication device 10 so that the first portable communication device 10 can be placed on a surface to enable video communication without requiring a user to hold the device. In such an orientation, for example, the electronic display 14 is visible to a user and the first image capture device 16 captures an image of the user (the first scene) and the second image capture device 18 captures images of at least a portion of a second scene observed by the user.

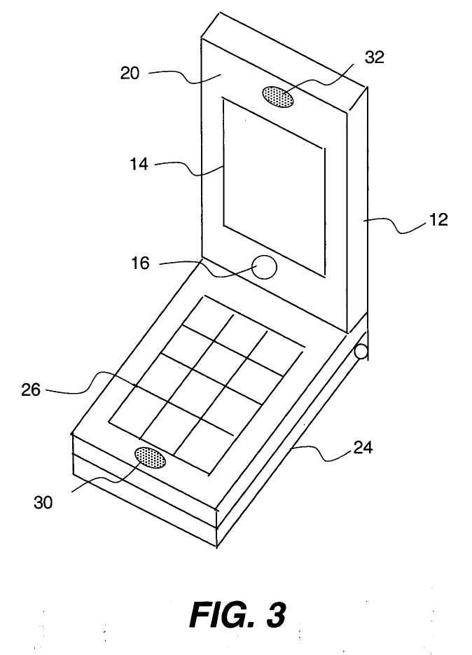

The mechanical stand 24 can fold into a folded position to reduce the profile of the first portable communication device 10 (as shown in FIG. 1) or extend into an extended position to support the first portable communication device 10 on a surface (as shown in FIG. 2). As shown in FIG. 1, the stand folds to the side of the keypad 26. In alternative embodiments of the present invention, the mechanical stand 24 can be provided beneath the keypad 26 (as shown in FIG. 3) or behind the display 14 (not shown).

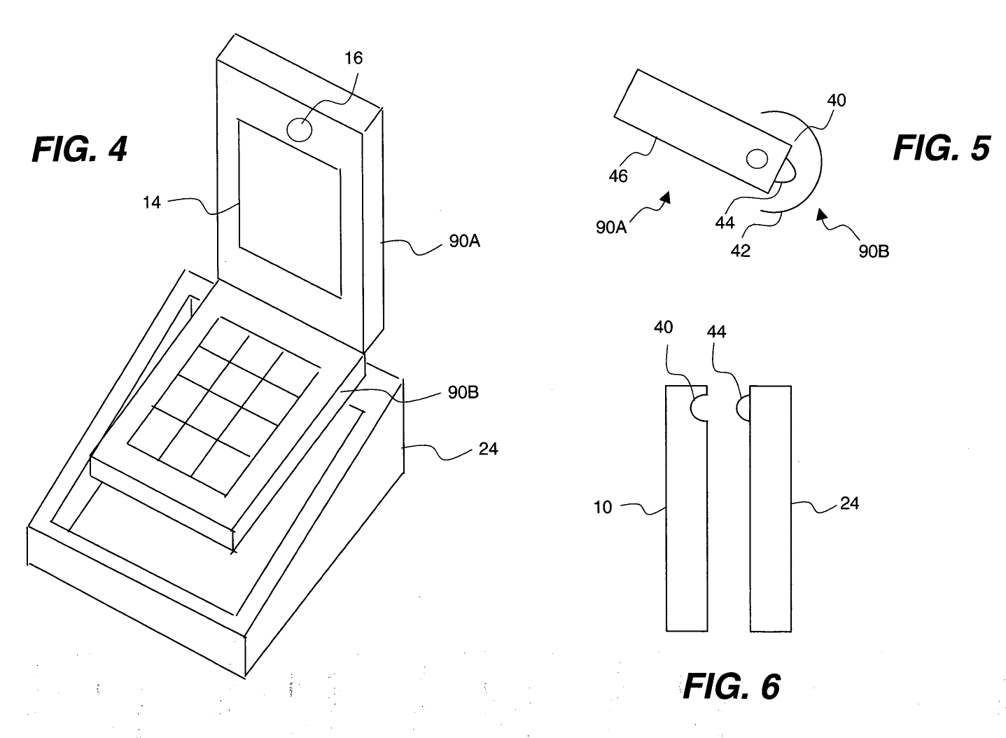

As shown in FIG. 4, in yet another embodiment of the present invention, the mechanical stand 24 can be a structure physically separated from the body of the first portable communication device 10 so that the first portable device 10 can be inserted into and rest in the mechanical stand 24 in a preferred orientation to enable user-friendly communication.

In another embodiment of the present invention, the first portable communication device can be a folding device comprising first and second folding portions 90A and 90B and the hands-free mechanism 24 can hold the folded portions 90A and 90B of the first portable communication device 10 at two or more desired angles with respect to each other. One of the folded portions (e.g. 90B) can be employed to support the first portable communication device on a surface. Referring to FIG. 5, in such an embodiment, the hands-free mechanism 24 employs two-or-more detents 40 in a first element 42 incorporated in a first folding portion 90A and a protrusion 44 in a second element 46 incorporated in the second folding portion 90B to hold the first and second folding portions 90A and 90B, respectively, at a desired angle.

Referring to FIG. 6, in yet another embodiment of the present invention, the mechanical stand 24 is detachable from the first portable communication device 10, for example by employing a protrusion 44 in the mechanical stand 24 and a detent 40 in the first portable communication device 10. In one configuration, the detent 40 and protrusion 44 are aligned and held in place by mechanical pressure supplied, for example, by the mechanical stand 24. In another configuration, the mechanical stand 24 is slightly and temporarily deformed to remove the stand 24 and the protrusion 44 from the detent 40 and first portable communication device 10. Such mechanical structures and materials (for example, plastics) useful in accomplishing this are well known in the art.

By providing a first portable communication device 10 having two image sensors and a mechanical stand, the first portable communication device may be located on a surface rather than being hand-held. Image acquisition may then be provided that is free of camera shake and can readily image, by using the first image sensor, the user, user gestures, or user-held objects. At the same time, a scene viewed by a user may also be imaged, enabling the high-quality communication of both the user or his or her environs, at the discretion of the user. Moreover, the user can view the communicated images on the display while image capture of him or herself or of another scene is progressing.

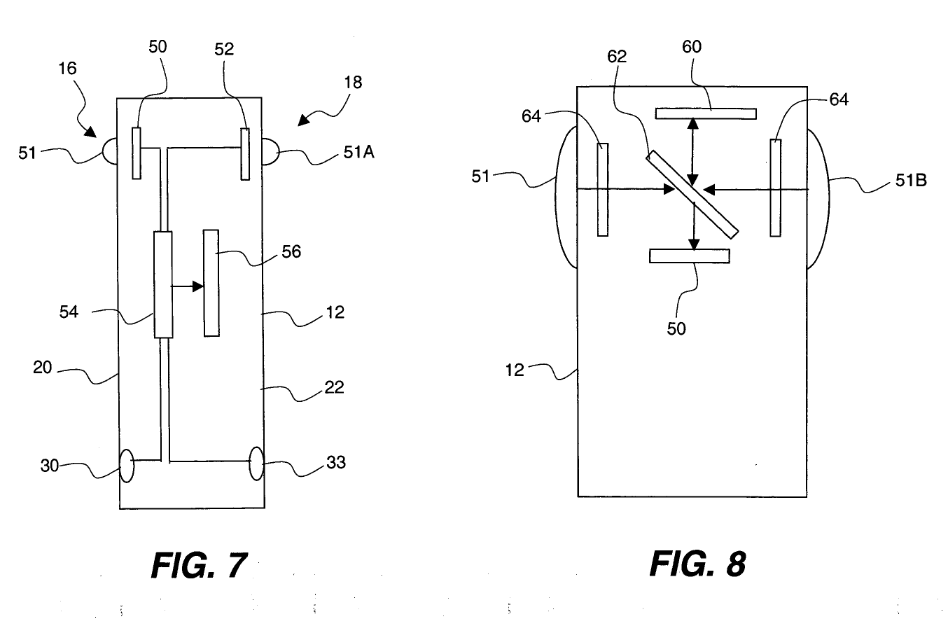

Referring to FIG. 7, in other embodiments of the present invention, the first and second image capture devices 16 and 18, respectively, can be separate digital cameras, each having a separate image sensor 50, 52, and lenses 51, 51A. In an alternative embodiment shown in FIG. 8, the first and second image capture devices 16 and 18 can have a common image sensor 50 and separate lenses 51 and 511B, together with imaging optics to combine light rays from each of the lenses 51 and 51B, for example comprising a beam splitter 62, mirror 60, and shutters 64. Such image combining optics are well known in the art, as are image sensors and lenses.

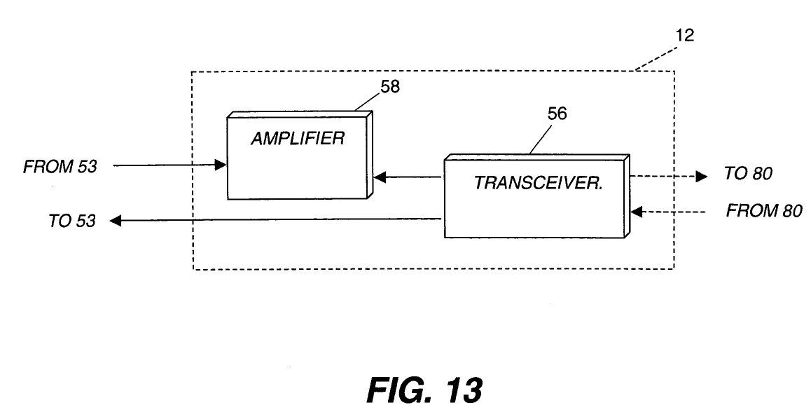

Referring back to FIG. 7, in yet another embodiment of the present invention, the first portable communication device 10 can further comprise a second microphone 33 located on the second side 22 located adjacent to the second scene to record an audio signal from the second scene and subtract the signal of the second microphone 33 from the signal of the microphone 30 to reduce ambient noise in the recorded audio signal. Alternatively signals can be transmitted from the first or second microphone alone or the audio signals can be combined, as might be useful in a concert setting for example. The microphone 30 can be located on the first side 20 of the portable communication device 12. In further embodiments of the present invention, the first portable communication device 10 can further extract the user's image captured by the first image capture device 16 and combine it with a scene image captured by the second image capture device 18 to form a combined image. Suitable computer or image- and audio/video processors 54 are known in the art. Referring to FIG. 13, the processed images and audio signals can be amplified by an amplifier 58 and transmitted by transceiver communication module circuits 56, as are commonly found in prior-art cellular telephones. The circuits can also respond to commands from a user, for example through the keypad or audio signals, to display the image captured by one image capture device 16 or the other 18.

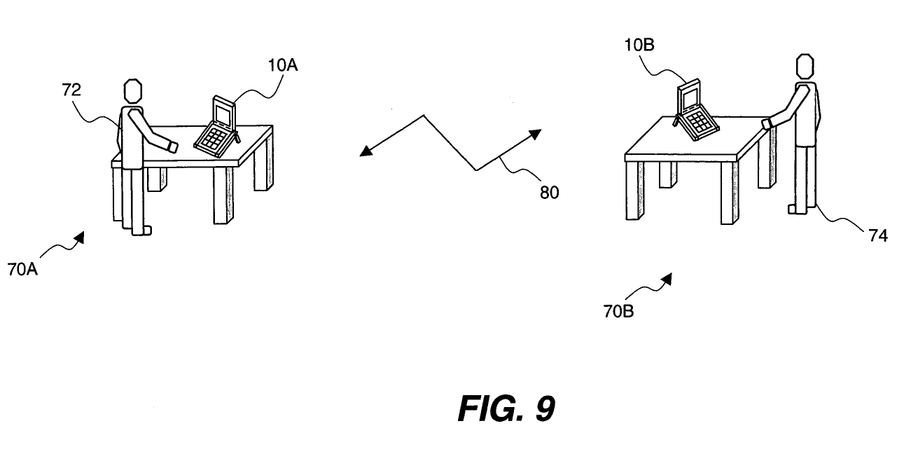

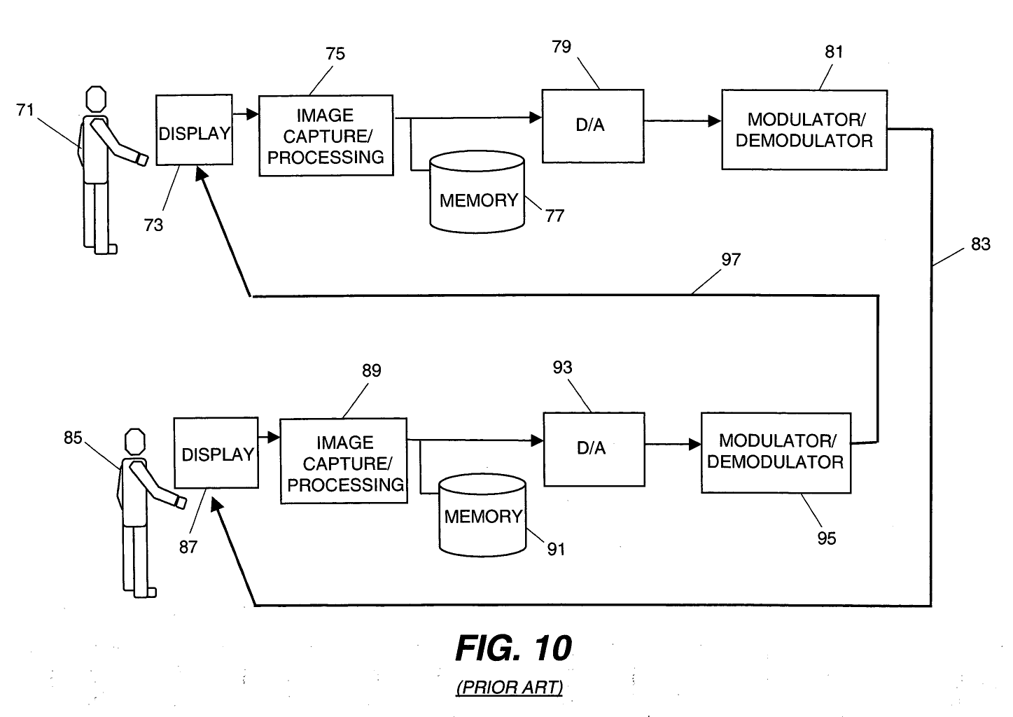

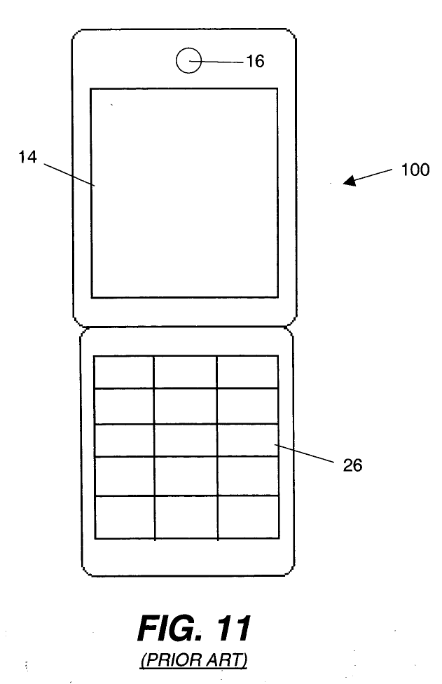

Referring to FIG. 9, the first portable communication device 10 of the present invention can be employed in a portable communication system comprising first and second portable communication devices 10A and 10B, respectively, each comprising: a communication module for transmitting and receiving video and audio information; an electronic display; a first image capture device for capturing an image of a first scene; a second image capture device for capturing an image of a second scene different from the first scene; and can respond to a user command for transmitting images of either the first or second scene or a combination thereof to the second portable communication device. The first and second portable video communication devices 10A and 10B are located at different sites 70A and 70B and can respond to two different users 72 and 74, respectively. A communications infrastructure 80 communicates the transmitted information from the first and second portable communication devices 10A and 10B to the receiver of the second and first portable communication devices, respectively.

It should be noted that drawings used to show embodiments of the present invention are not drawn to scale, but are illustrative of key components and principles used in these embodiments. Moreover, it must be emphasized that the apparatus of the present invention can be embodied in a number of different types of systems, using a wide variety of types of supporting hardware and software.

The invention has been described in detail with particular reference to certain preferred embodiments thereof, but it will be understood that variations and modifications can be effected within the spirit and scope of the invention. It should be understood that the various drawing and figures provided within this invention disclosure are intended to be illustrative of the inventive concepts and are not to scale engineering drawings.

### PARTS LIST

10, 10A first portable communication device
10B second portable communication device
12 communication module
14 electronic display screen
16 first image capture device
18 second image capture device
20 first side
22 second side
24 mechanical stand
26 keypad
30 microphone
32 speaker
33 second microphone
40 detent
42 first element
44 protrusion
46 second element
50 image sensor
51 lens
51A lens
51B lens
52 image sensor
53 CPU
54 audio/video processor
56 receiver and transmitter circuit
58 amplifier
60 mirror
62 beamsplitter
64 shutter
70A first site
70B second site
71 first viewer
72 user
73 first display
74 user
75 first image capture device
77 first image capture device
79 first still image memory
80 communication infrastructure
81 first modulator/demodulator
83 first communication channel
85 second viewer
87 second display
89 second image capture device
90A folded portion
90B folded portion
91 second still image memory
93 second D/A converter
95 second modulator/demodulator
97 second communication channel
100 cellular phones

1. A first portable communication device for communicating with a second portable communication device, the first portable communication device comprising:
a) a communication module for transmitting and receiving video and audio information;
b) an electronic display;
c) a first image capture device for capturing an image of a first scene;
d) a second image capture device for capturing an image of a second scene different from the first scene; and
e) means responsive to a user command for transmitting images of either the first or second scene or a combination thereof to the second portable communication device.

2. The first portable communication device of claim 1, further including a microphone for receiving audio information from the user and for transmitting such audio information as the images are transmitted.

3. The first portable communication device of claim 1, wherein the user command further includes means for displaying an image of the first scene on the electronic display and for selecting portions of such image to be combined with the second scene prior to transmitting the combined image.

4. The first portable communication device of claim 1, wherein the images are either still or video images.

5. The first portable communication device of claim 1, further including means responsive to a user command for displaying images of either the first or second scene.

6. The first portable communication device of claim 1, wherein the first portable communication device further includes means for receiving and displaying video images from the second portable communication device and for receiving and playing audio received from the second portable communication device.

7. The first portable communication device of claim 1, wherein the first and second image capture devices are separate digital cameras, each having a separate image sensor and lens.

8. The first portable communication device of claim 1, wherein the first and second image capture devices have a common image sensor and separate lenses.

9. The first portable communication device of claim 1, further including a first microphone located adjacent to the first scene and a second microphone located adjacent to the second scene to form audio signals and further comprising means to select and combine the audio signals from each microphone; broadcasting only the signal from the first microphone; or broadcasting the signal from only the second microphone.

10. The first portable communication device of claim 1, further including a first microphone located adjacent to the first scene and a second microphone located adjacent to the second scene to form audio signals and further comprising means to subtract the audio signal of the second microphone from the audio signal of the first microphone and broadcasting only the audio signal difference.

11. The first portable communication device of claim 1, further comprising means for extracting the user's image captured by the first image capture device and combining it with a scene image captured by the second image capture device to form a combined image.

12. The first portable communication device of claim 1, further including a hands-free mechanism for orienting the first portable communication device such that the electronic display is visible to the user and the first image capture device captures an image of the user and the second image capture device captures images of at least a portion of a scene observed by the user.

13. The first portable communication device of claim 12, wherein the hands-free mechanism is a mechanical stand.

14. The first portable communication device of claim 13, wherein the mechanical stand is integrated into the first portable communication device.

15. The first portable communication device of claim 13, wherein the mechanical stand is detachable from the first portable communication device.

16. The first portable communication device of claim 13, wherein the mechanical stand is a separate structure into which the first portable communication device is inserted.

17. The first portable communication device of claim 12, wherein the portable communication device is a folding device having first and second folding portions and the hands-free mechanism holds the folded portions of the first portable communication device at two or more desired angles with respect to each other and wherein one of the folded portions is employed to support the first portable communication device on a surface.

18. The first portable communication device of claim 11, wherein the hands-free mechanism employs two-or-more detents in a first element incorporated in the first folding portion and a protrusion in a second element incorporated in the second folding portion to hold the first and second folding portions at a desired angle.
